(19) United States
(12) Patent Application Publication
(10) Pub. No.: US 2014/0055943 A1
(43) Pub. Date: Feb. 27, 2014

(54) METAL SHOCK ABSORBER, ASSEMBLY OF METAL SHOCK ABSORBER AND MEDIA RECORDING UNIT AND MEDIA RECORDING DEVICE

(71) Applicants: Cal-Comp Electronics & Communications Company Limited, (US); KINPO ELECTRONICS, INC., New Taipei City (TW)

(72) Inventors: Hung-Wei Chang, New Taipei City (TW); Yih-Her Lin, New Taipei City (TW)

(73) Assignees: Kinpo Electronics, Inc., New Taipei City (TW); Cal-Comp Electronics & Communications Company Limited, New Taipei City (TW)

(21) Appl. No.: 13/831,727

(22) Filed: Mar. 15, 2013

(30) Foreign Application Priority Data
Aug. 23, 2012 (TW) 101130661

(51) Int. Cl. F16F 1/02; G06F 1/16

(52) U.S. Cl. CPC F16F 1/025; G06F 1/1658
USPC 361/679.35; 267/136

(57) ABSTRACT

A metal shock absorber, an assembly of a metal shock absorber and a media recording unit, and a media recording device are provided. The metal shock absorber has a pair of horizontal portions, a perpendicular portion connected between the horizontal portions, and a pair of limiting portions. Each of the horizontal portions has a first arcuate protrusion protruding towards another first arcuate protrusion. The perpendicular portion is perpendicularly connected between the pair of horizontal portions, and has an assembling arm. The limiting portions are disposed at opposite sides of the perpendicular portion that are not connected with the horizontal portions. Since the thickness, the tolerance and costs of the metal shock absorber are less than those of the conventional rubber shock absorber, the assembly of the metal shock absorber with the media recording unit has a favorable assembly reliability, and therefore costs of the recording device are effectively lowered.

### CROSS-REFERENCE TO RELATED APPLICATION

This application claims the priority benefit of Taiwan application serial no. 101130661, filed on Aug. 23, 2012. The entirety of the above-mentioned patent application is hereby incorporated by reference herein and made a part of this specification.

### BACKGROUND

1. Field of the Invention

The invention relates to a metal shock absorber, an assembly of a metal shock absorber and a media recording unit, and a media recording device. More particularly, the invention relates to a metal shock absorber, an assembly of the metal shock absorber and a media recording unit, and a media recording device using the metal shock absorber.

2. Description of Related Art

In an era of information and digital, people have increasingly depended on computers to handle work and day-to-day affairs, and thus the computers have become technology necessities in integral parts of human daily life. However, following advances in technology and increased consumer demands, the demands for a media recording device configured to expand and increase a storage space have also increased relatively.

Since the media recording device has advantages of high storage density, high-capacity, low storage cost, quick speed, and random accessibility, it has become one of the mainstream storage systems. In addition, the design of the conventional media recording device is no longer just confined to be installed within a host computer, such that an external media recording device may further provide conveniences of use (e.g., portability, private confidentiality, and capability of plug and play), and therefore is well-received by the general public.

However, since the media recording device is in fact a product easily prone to damage, it may breakdown easily with a little shock; especially, with the recently increased popularity of the external media recording device, a probability of damaging the media recording device due to relative shocks generated by users carrying is also greater.

FIG. 1A and FIG. 1B are exploded schematic views illustrating two conventional media recording devices according to related arts. Referring to FIG. 1A and FIG. 1B at the same time, in the conventional media recording device, a shock absorber sandwiched between a casing and a media recording unit is produced with soft rubber, wherein the shock absorber 110a shown in FIG. 1A is able to be directly inserted into the media recording unit 120a, while the shock absorber 110b shown in FIG. 1B is locked into the media recording unit 120b by being passed through with fixing elements 130. In order to achieve a favorable shock absorbing effect, thicknesses of the rubber shock absorbers 110a, 110b have to be thick enough, and therefore overall sizes of the media recording devices 120a, 120b are limited in relative. Moreover, rubber is rather limited in the choice of forming method, and thus it is relatively expensive in costs. In detail, the structure of the shock absorber unit 110b as shown in FIG. 1B is relatively simple, and therefore the costs and the formation time thereof are less than the costs and formation time of the shock absorber unit 110a with a relatively complex structure as shown in FIG. 1A. In addition, when using rubber to produce the shock absorber 110a with the relatively complex structure as shown in FIG. 1A, the tolerance thereof would be more uneven, thus also causing the assembly reliability of each component in the media recording device 100a to be less than desirable.

### SUMMARY OF THE INVENTION

The invention provides a low cost metal shock absorber.

The invention provides an assembly of a metal shock absorber and a media recording unit with a favorable assembly reliability.

The invention provides a media recording device with low costs and a favorable assembly reliability.

The invention provides a metal shock absorber having a pair of horizontal portions, a perpendicular portion and a pair of limiting portions, wherein each of the horizontal portions has a first arcuate protrusion protruding towards another arcuate protrusion. The perpendicular portion is perpendicularly connected between the pair of horizontal portions, and has an assembling arm. The limiting portions are disposed at opposite sides of the perpendicular portion that are not connected with the pair of horizontal portions.

The invention further provides an assembly of a metal shock absorber and a media recording unit, including a media recording unit, a plurality of metal shock absorbers and a plurality of fixing elements, wherein each of the metal shock absorbers has a pair of horizontal portions, a perpendicular portion and a pair of limiting portions. Each of the horizontal portions has a first arcuate protrusion protruding towards another arcuate protrusion to jointly hold up the media recording unit. The perpendicular portion is perpendicularly connected between the pair of horizontal portions and located outside of the media recording unit. The perpendicular portion has an assembling arm leaned against the media recording unit. The pair of limiting portions is disposed at opposite sides of the perpendicular portion that are not connected with the pair of horizontal portions. The fixing elements are correspondingly passed through the assembling arms and inserted into the media recording unit to secure the metal shock absorbers and the media recording unit with each other.

The invention also provides a media recording device including a casing, a media recording unit, a plurality of metal shock absorbers, and a plurality of fixing elements. The casing has a plurality of limiting chutes arranged in pairs, and the media recording unit is disposed in the casing. Each of the metal shock absorbers has a pair of horizontal portions, a perpendicular portion and a pair of limiting portions. Each of the horizontal portions has a first arcuate protrusion protruding towards another arcuate protrusion to jointly hold up the media recording unit. The perpendicular portion is perpendicularly connected between the pair of horizontal portions and located outside of the media recording unit. The perpendicular portion has an assembling arm leaned against the media recording unit. The pair of limiting portions is disposed at opposite sides of the perpendicular portion that are not connected with the pair of horizontal portions, and the pair of limiting portions is correspondingly located in the limiting chutes. The fixing elements are correspondingly passed through the assembling arms and inserted into the media recording unit to secure the metal shock absorbers and the media recording unit with each other.

According to the foregoing, the metal shock absorber of the invention, in comparison with the conventional rubber shock absorber, has the advantages of easy produce, smaller tolerance and relatively low costs. Therefore, the assembly of the metal shock absorber and the media recording unit has a favorable assembly reliability, and thus costs of the recording device are effectively lowered.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A and FIG. 1B are exploded schematic views illustrating two conventional media recording devices according to related arts.

FIG. 2A and FIG. 2B are perspective views from different angles illustrating a metal shock absorber according to the first embodiment of the invention.

FIG. 3 and FIG. 4 are perspective views from different angles illustrating an assembly of a metal shock absorber and a media recording unit according to the second embodiment of the invention.

FIG. 5 is an assembly diagram of a media recording device according to a third embodiment of the invention.

FIG. 6 is an exploded schematic view illustrating the media recording device in FIG. 5.

FIG. 7 is a cross-sectional view along a profile line A-A in FIG. 5.

FIG. 8 is a schematic view illustrating a metal shock absorber according to a fourth embodiment of the invention.

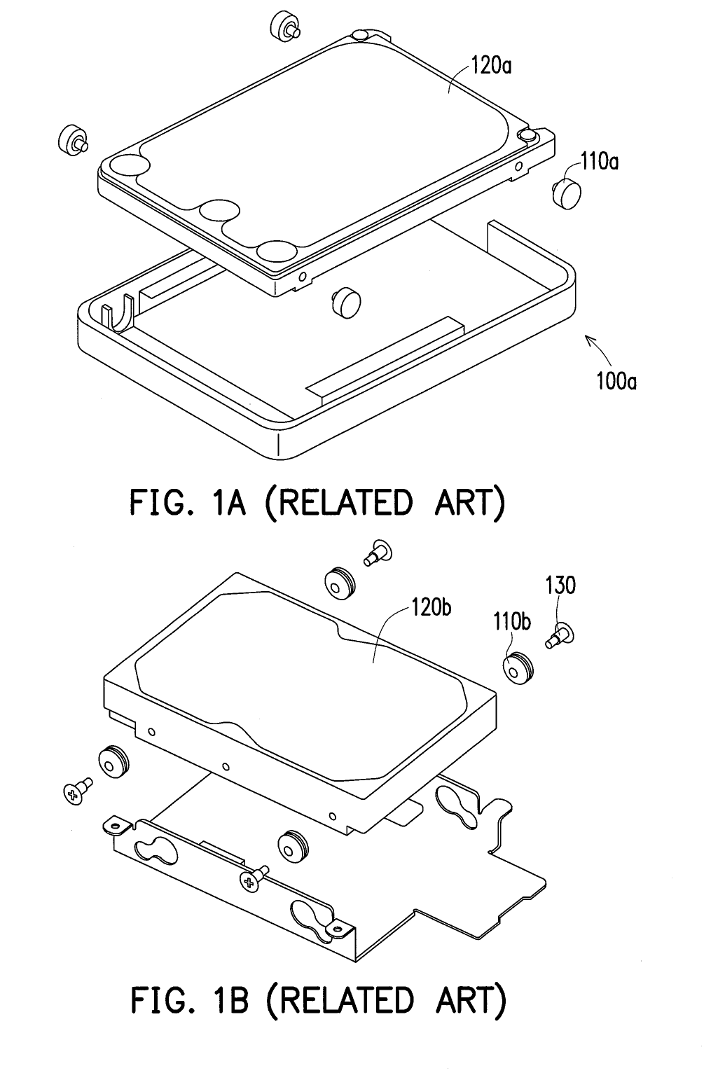

### DETAILED DESCRIPTION OF DISCLOSED EMBODIMENTS

### First Embodiment

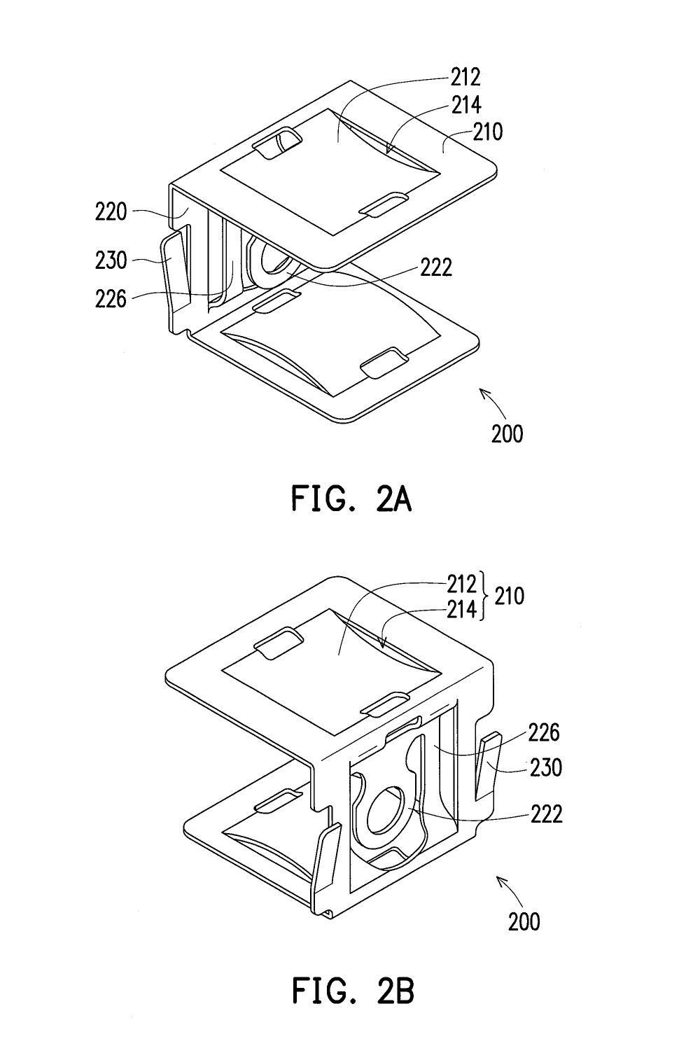

FIG. 2A and FIG. 2B are perspective views from different angles illustrating a metal shock absorber according to the first embodiment of the invention. Referring to FIG. 2A and FIG. 2B at the same time, the metal shock absorber 200 of the present embodiment has a pair of horizontal portions 210, a perpendicular portion 220 and a pair of limiting portions 230, wherein each of the horizontal portions 210 has a first arcuate protrusion 212 protruding towards another arcuate protrusion 212. The perpendicular portion 220 is perpendicularly connected between the pair of horizontal portions 210, and has an assembling arm 222. The limiting portions 230 are disposed at opposite sides of the perpendicular portion 220 that are not connected with the horizontal portions 210.

In detail, since each first arcuate protrusion 212 is formed by post-processing (e.g., stamping) the horizontal portions 210, each of the horizontal portions 210 further includes a pair of openings 214, and this pair of openings 214 are located at opposite sides of the first arcuate protrusion 212. The assembling arm 222 is generally located in the central position of the perpendicular portion 220, and the assembling arm 222 may also be formed by stamping the perpendicular portion 220; therefore, the perpendicular portion 220 has an opening (not shown) in a shape generally complied with the assembling arm 222. In addition, the limiting portions 230 are arms formed by inward cropping the edges of the opposite sides of the perpendicular portion 220 and bending the cropped portions, and the ends of the arms that are connected with the perpendicular portion 220 are bending towards outside of the metal shock absorber 200, such that the arms are bending towards a direction opposite to an extending direction of two horizontal portions 210.

Referring continuously to FIG. 2A and FIG. 2B at the same time, the perpendicular portion 220 of the present embodiment may further has a second arcuate protrusion 226, the second arcuate protrusion 226 is protruding towards a space formed between the two horizontal portions 210, and the assembling arm 222 is located in the second arcuate protrusion 226. A degree of protruding the second arcuate protrusion 226 towards the space between the horizontal portions 210 may be equal to or smaller than a degree of protruding the assembling arm 222 towards the space between the horizontal portions 210, which is selected according to the actual needs.

In comparison with the conventional rubber shock absorber, the metal shock absorber 200 of the present embodiment has the advantages of easy produce, smaller tolerance and relatively low costs.

### Second Embodiment

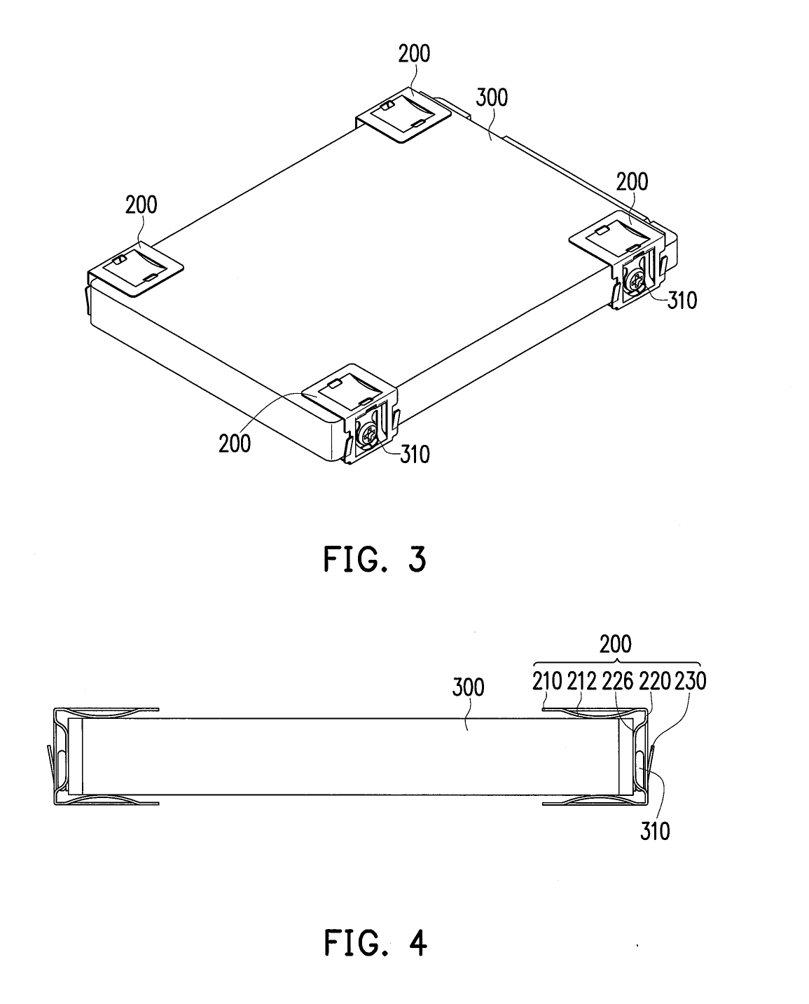

FIG. 3 and FIG. 4 are perspective views from different angles illustrating an assembly of a metal shock absorber and a media recording unit according to the second embodiment of the invention. Referring to FIG. 2A, FIG. 3 and FIG. 4 at the same time, the assembly of the metal shock absorber 200 and the media recording unit 300 includes a media recording unit 300, a plurality of metal shock absorber 200 described in the previous embodiment, and a plurality of fixing elements 310. Each of the metal shock absorbers 200, via the first arcuate protrusion 212 of the horizontal portions 210 thereof, jointly holds up the media recording unit 300, and the perpendicular portion 220 is located outside of the media recording unit 300 for enabling the fixing elements 310 to pass through the corresponding assembling arm 222 and insert into the media recording unit 300, so that the metal shock absorber 200 is fixed at the media recording unit 300.

In the present embodiment, the fixing elements 310 are screws or tenon, and therefore a fixation of the metal shock absorber 200 and the media recording unit 300 may be performed by passing the screws through the assembling arm 222 to lock into the media recording unit 300, or by passing the tenon through the assembling arm 222 to wedge into the media recording unit 300. In addition, although the present embodiment has taken four metal shock absorbers 200 assembled at the four corners of the media recording unit 300 as an example for the description purpose, the use amount and the location of the metal shock absorber 200 are not limited thereto and may be modified according to the actual needs.

In addition, since the perpendicular portion 220 of the metal shock absorber 200 applied to the present embodiment further has the second arcuate protrusion 226, which protrudes to the space between the horizontal portions 210, and the degree of protruding the second arcuate protrusion 226 towards the space between the horizontal portions 210 is smaller than the degree of protruding the assembling arm 222 towards the space between the horizontal portions 210, when the media recording unit 300 is subjected to an impact while a first buffer protection effect provided by the assembling arm 222 is still insufficient, the second arcuate protrusion 226 may further enable the media recording unit 300 to lean against thereon, so as to provide a second buffer protection effect.

Moreover, since the metal shock absorber 200 may obtain a favorable dimensional accuracy during the production, the assembly of the metal shock absorber 200 and the media recording unit 300 has a favorable assembly reliability.

### Third Embodiment

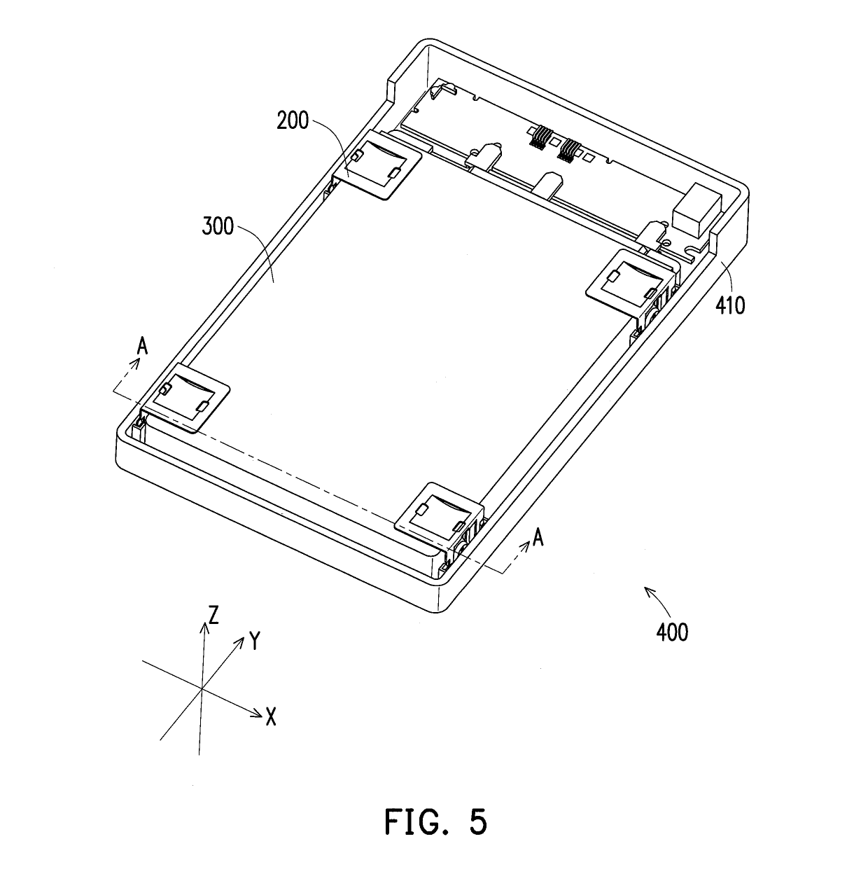

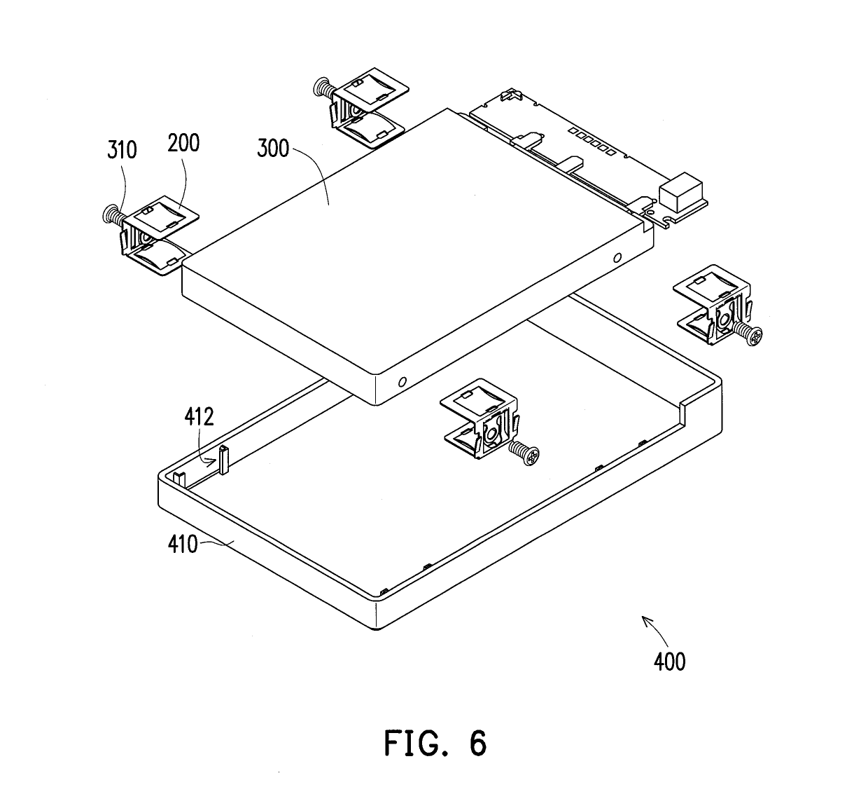

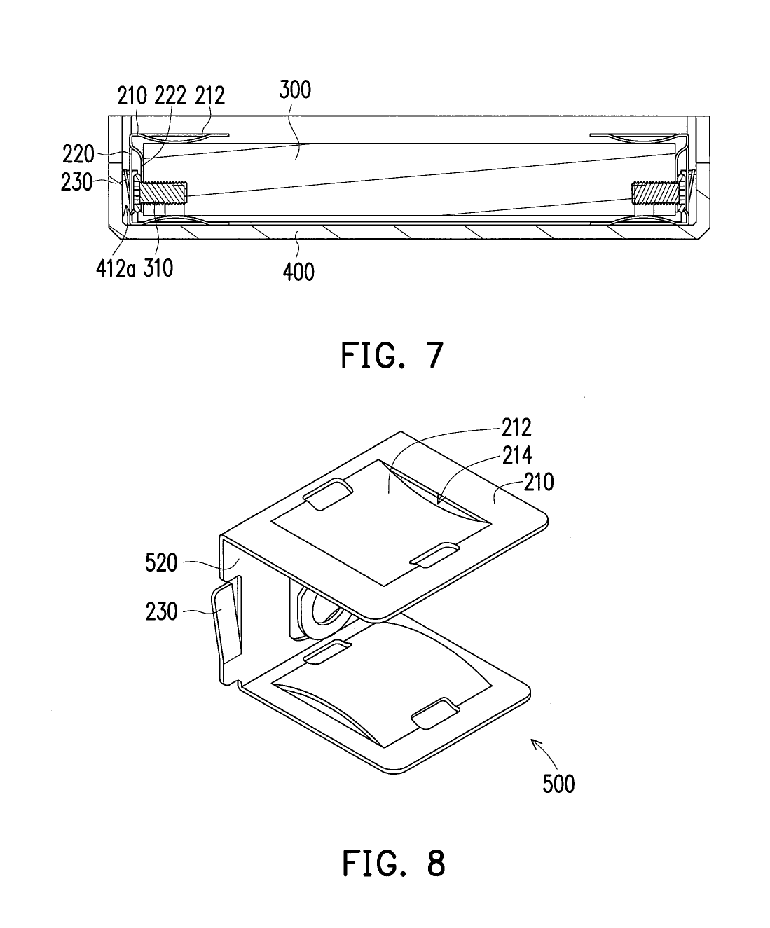

FIG. 5 is an assembly diagram of a media recording device according to the present embodiment, FIG. 6 is an exploded schematic view illustrating the media recording device in FIG. 5, and FIG. 7 is a cross-sectional view along a profile line A-A in FIG. 5. Referring to FIG. 5, FIG. 6 and FIG. 7 at the same time, the media recording device 400 includes a casing 410 and the assembly of the metal shock absorber 200 and the media recording unit 300 described in the second embodiment. It is noted that, in order to clearly illustrate relative movements between the elements, a longitudinal direction X, a width direction Y and a height direction Z of a three-dimensional space are therefore defined in the drawing, and the following brief descriptions regarding to the relative movements between the elements are then provided with the terms X direction, Y direction and Z direction. Those of skilled in the art would be able to understand that the terms X direction, Y direction and Z direction, as described in the following, are solely used for a convenience in illustrating the present embodiment, and thus are not intended to limit the invention.

In detail, the casing 410 has a plurality of limiting chutes 412 arranged in pairs for limiting the assembly of the metal shock absorber 200 and the media recording unit 300 to be assembled into the casing 410 in the Z direction. When assembling the assembly of the metal shock absorber 200 and the media recording unit 300 into the casing 410, the limiting portions 230 are correspondingly wedged into and located at the limiting chutes 412, and since the ends of the arm, namely the limiting portions 230, which are not connected with the perpendicular portion 220, are bending towards outside of the metal shock absorber 200, the limiting portions 230 are leaned against chute walls of the limiting chutes 412. By leaning the limiting portions 230 against the chute walls 412a of the limiting chutes 412, the limiting portions 230 may limit a relative movement between the metal shock absorber 200 and the casing 410 in the X direction and the Z direction at the same time.

Incidentally, the limiting portions 230 are presented as arms, which not only may limit the relative movement between the metal shock absorber 200 and the casing 410, but also may further provide a buffering effect via a deformation of the arms when the assembly of the metal shock absorber 200 and the media recording unit 300 has a movement in relative to the casing 410 in the X direction, so as to reduce the chances of impacting the metal shock absorber 200 and the media recording unit 300 against the limiting chutes 412.

In addition, the media recording device 400 further has a top cover (not shown) covering above the casing 410 for limiting the assembly of the metal shock absorber 200 and the media recording unit 300 to move in the Z direction, so that the assembly of the metal shock absorber 200 and the media recording unit 300 is unable to move away from the casing 410 in the Z direction.

When the media recording device 400 is subjected to an impact, the assembly of the metal shock absorber 200 and the media recording unit 300 in relative to the casing 410 may have movements in the X direction, the Y direction and the Z direction at the same time. Although the media recording unit 300, via the limiting chutes 412 and the limiting portions 230 of the metal shock absorber 200, is limited in the Y direction, the media recording unit 300, via the deformation of the assembling arm 222 of the perpendicular portion 220, still has a margin in the Y direction allowing a slight movement relative to the casing 410, thus achieving a shock absorbing effect. In addition, although the top cover and the limiting portions 230 of the metal shock absorber 200 may limit the movement of the media recording unit 300 in the Z direction, an impact force received by the media recording unit 300 in the Z direction, via a deformation and a deformation restoring ability of the first arcuate protrusion 212 of the horizontal portions 210, may also be buffered, so as to prevent the media recording unit 300 from directly impacting the top cover or the bottom of the casing 410.

Moreover, the first buffer protection effect in the X direction, via also the assembling arm 222 of the perpendicular portion 220 of the metal shock absorber 200, may be provided to the media recording unit 300, thus achieving a shock absorbing effect. When this buffer protection effect is still insufficient to completely resist the impact force, the media recording unit 300 is further leaned against the second arcuate protrusion 226, so as to provide the second buffer protection effect to the media recording unit 300 via a deformation and a deformation restoring ability of the second arcuate protrusion 226.

According to the above, since the metal shock absorber 200 may have a deformation in the X direction, the Y direction and the Z direction of the three-dimensions (in the Z direction is a deformation of the first arcuate protrusion 212, in the X direction and the Y direction is a deformation of the assembling arm 222, and in the X direction further has a deformation of the second arcuate protrusion 226), a shock absorbing effect provided for the media recording unit 300 is excellent.

### Fourth Embodiment

The present embodiment is generally similar to the first embodiment, and the same or similar reference number indicate the same or similar element, wherein the metal shock absorber of the present embodiment may also be applied to the assembly of the metal shock absorber and the media recording unit of the second embodiment or the media recording device of the third embodiment, and detailed descriptions of the similarities are not repeated herein, the following below only describes the differences.

FIG. 8 is a schematic view illustrating the metal shock absorber of the present embodiment. Referring to FIG. 2A and FIG. 8, a difference between the metal shock absorber of the present embodiment and the metal shock absorber of the first embodiment is that, a perpendicular portion 520 of the metal shock absorber of the present embodiment does not have the second arcuate protrusion 226. As a result, a machining process may be reduced in the production of the metal shock absorber 500, and thus the costs may be lowered, and a production rate of the metal shock absorber 500 may also be speed up.

In summary, the metal shock absorber of the invention has the advantages of simpler and easier production process, more easily controllable dimensional accuracy and lower costs, as compared to the conventional rubber shock absorber. Herein, the metal shock absorber and the media recording unit are jointly assembled together, and the assembly thereof has a favorable assembly reliability capable of more effectively lowering the costs of the media recording device.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A metal shock absorber having:
a pair of horizontal portions, wherein each of the horizontal portions has a first arcuate protrusion protruding towards another arcuate protrusion;
a perpendicular portion perpendicularly connected between the pair of horizontal portions, and having an assembling arm; and
a pair of limiting portions disposed at opposite sides of the perpendicular portion that are not connected with the pair of horizontal portions.

2. The metal shock absorber as recited in claim 1, wherein each of the horizontal portions has a pair of openings located at opposite sides of the first arcuate protrusion.

3. The metal shock absorber as recited in claim 1, wherein the pair of limiting portions are a pair of arms formed by cropping edges of the perpendicular portion and bending the cropped portions.

4. The metal shock absorber as recited in claim 1, wherein the perpendicular portion further has a second arcuate protrusion protruding towards a space between the horizontal portions, and the assembling arm is located in the second arcuate protrusion.

5. The metal shock absorber as recited in claim 4, wherein a degree of protruding the second arcuate protrusion towards the space between the horizontal portions is smaller than a degree of protruding the assembling arm towards the space between the horizontal portions.

6. An assembly of a metal shock absorber and a media recording unit, comprising:
a media recording unit;
a plurality of metal shock absorbers, wherein each metal shock absorbers has a pair of horizontal portions, a perpendicular portion and a pair of limiting portions, each of the horizontal portions has a first arcuate protrusion protruding towards another arcuate protrusion to jointly hold up the media recording unit, and the perpendicular portion is perpendicularly connected between the pair of horizontal portions and located outside of the media recording unit, the perpendicular portion has an assembling arm leaned against the media recording unit, the pair of limiting portions is disposed at opposite sides of the perpendicular portion that are not connected with the pair of horizontal portions; and
a plurality of fixing elements correspondingly passed through the assembling arms and inserted into the media recording unit to secure the metal shock absorbers and the media recording unit with each other.

7. The assembly of the metal shock absorber and the media recording unit as recited in claim 6, wherein each of the horizontal portions has a pair of openings located at opposite sides of the first arcuate protrusion.

8. The assembly of the metal shock absorber and the media recording unit as recited in claim 6, wherein the pair of limiting portions are arms formed by cropping the edges of the perpendicular portion and bending the cropped portions.

9. The assembly of the metal shock absorber and the media recording unit as recited in claim 6, wherein the perpendicular portion further has a second arcuate protrusion protruding towards a space between the pair of horizontal portions, and the assembling arm is located in the second arcuate protrusion.

10. The assembly of the metal shock absorber and the media recording unit as recited in claim 9, wherein the assembling arm is located between the media recording unit and the second arcuate protrusion.

11. The assembly of the metal shock absorber and the media recording unit as recited in claim 6, wherein the fixing elements are screws or tenon.

12. A media recording device comprising:
a casing having a plurality of limiting chutes arranged in pairs;
a media recording unit disposed in the casing;
a plurality of metal shock absorbers, wherein each of the metal shock absorbers has a pair of horizontal portions, a perpendicular portion and a pair of limiting portions, each of the horizontal portions has a first arcuate protrusion protruding towards another arcuate protrusion to jointly hold up the media recording unit, and the perpendicular portion is perpendicularly connected between the pair of horizontal portions and located outside of the media recording unit, the perpendicular portion has an assembling arm leaned against the media recording unit, the pair of limiting portions is disposed at opposite sides of the perpendicular portion that are not connected with the pair of horizontal portions, and the pair of limiting portions are correspondingly located in the limiting chutes; and
a plurality of fixing elements correspondingly passed through the assembling arms and inserted into the media recording unit to secure the metal shock absorbers and the media recording unit with each other.

13. The media recording device as recited in claim 12, wherein each of the horizontal portions has a pair of openings located at opposite sides of the first arcuate protrusion.

14. The media recording device as recited in claim 12, wherein the pair of limiting portions are arms formed by cropping the edges of the perpendicular portion and bending the cropped portions.

15. The media recording device as recited in claim 12, wherein the perpendicular portion further has a second arcuate protrusion protruding towards a space between the pair of horizontal portions, and the assembling arm is located in the second arcuate protrusion.

16. The media recording device as recited in claim 15, wherein the assembling arm is located between the media recording unit and the second arcuate protrusion.

17. The media recording device as recited in claim 12, wherein the fixing elements are screws or tenon.
